(19) United States
(12) Patent Application Publication
(10) Pub. No.: US 2006/0050463 A1
(43) Pub. Date: Mar. 9, 2006

(54) Heat detector for main board

(75) Inventors: Chih-Jen Hung, Taipei (TW); Hsu-Huang Cheng, Taipei (TW); Tsorng-Yang Mei, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/132,264

(22) Filed: May 19, 2005

(30) Foreign Application Priority Data
Sep. 7, 2004 (TW) 093127077

(51) Int. Cl. H02H 7/00

(52) U.S. Cl. 361/103

(57) ABSTRACT

A heat detector for a main board at least comprises a current generation unit, a heat perception element, and an analog to digital converter (ADC). The current generation unit generates at least one current signal. The heat perception element electrically connects to the current generation unit and generates an analog signal according to the current signal. The ADC electrically connects to the current generation unit and the heat perception element. The ADC is for converting the analog signal into a digital signal.

### BACKGROUND OF THE INVENTION

1. Field of Invention

The invention relates to a heat detector for a main board and, in particular, to a current heat detector for a main board.

2. Related Art

With the advance in the electronic technology, the central processing unit (CPU) become more powerful in its functions and faster in its processing speed. However, a problem induced by the powerful functions and fast processing speed is the complicated layout of a circuit board and the increasing temperature on the CPU. The complicated layout results in insufficient circuit space on the circuit board. The increasing temperature may result in burning of the CPU or peripheral elements.

Regarding to the temperature control, one method is to add a fan for the CPU. However, if the rotational speed of the fan is not properly controlled, the fan may always rotate at full speed and waste the power even when the temperature of the CPU is lower. Therefore, it is necessary to have a heat detector to detect the temperature and thus to control the fan's speed.

As shown in FIG. 1, a conventional heat detector consists of a reference voltage generator 11, an analog to digital converter (ADC) 12, a resistor R₁, and a thermal resistor R₂. The reference voltage generator 11 generates a first voltage V₁. After the action of the resistor R₁ and the thermal resistor R₂, a second voltage V₂ is obtained on the thermal resistor R₂. The ADC 12 generates a digital signal according to the second voltage V₂. The digital signal is used to control the rotational speed of the fan. In particular, the partial voltage formula is as follows:

$${V}_{2} = \frac{{R}_{2}}{{R}_{1} + {R}_{2}} \times {V}_{1} .$$

In the conventional heat detector, the reference voltage generator 11 generates a fixed first voltage V₁. Moreover, the resistor R₁ is a resistor with a fixed resistance. The resistance value of the thermal resistor R₂ varies with temperature. From the above formula, we see that the second voltage V₂ on the thermal resistor R₂ also varies with temperature. Accordingly, the ADC 12 controls the rotational speed of the fan in response to the different digital signals generated according to the second voltage V₂.

In general, the reference voltage generator 11 and the ADC 12 of the heat detector are usually installed on a single chip 15. Therefore, the chip 15 needs to have a first pin 151, a second pin 152, and a third pin 153 connected to the resistor R₁ and the thermal resistor R₂ provided outside the chip 15.

However, the conventional heat detector cannot accurately control and maintain the reference voltage value. Moreover, the circuit layout space around the CPU is very limited. Therefore, how to minimize the space of the heat detector on the main board while ensuring its ability of accurate controls is an important subject of the field.

### SUMMARY OF THE INVENTION

In view of the foregoing, the invention is to provide a heat detector for a main board to increase circuit layout space thereof.

To achieve the above, a heat detector for a main board of the invention at least includes a current generation unit, a heat perception element, and an analog to digital converter (ADC). The current generation unit generates at least one current signal. The heat perception element electrically connects to the current generation unit and generates an analog signal according to the current signal. The ADC electrically connects to the current generation unit and the heat perception element. The ADC is for converting the analog signal into a digital signal, wherein the current generation unit and the ADC can be integrated in a chip.

As mentioned above, the heat detector for a main board of the invention employs the current generation unit to substitute the conventional reference voltage generator for detecting heat. Thus, the heat detector of the invention has fewer components so as to increase the layout space on the main board.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional heat detector;

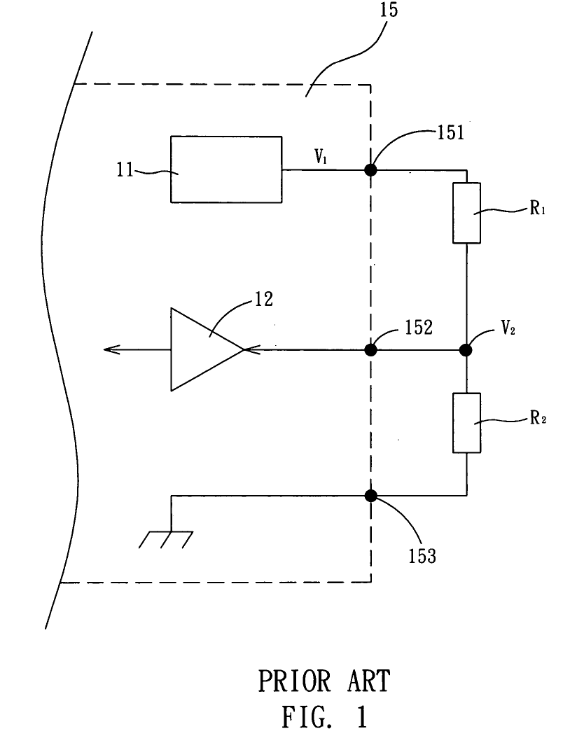

FIG. 2 is a schematic view of a heat detector for a main board according to a preferred embodiment of the invention; and

FIG. 3 is a schematic view of another heat detector for a main board according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

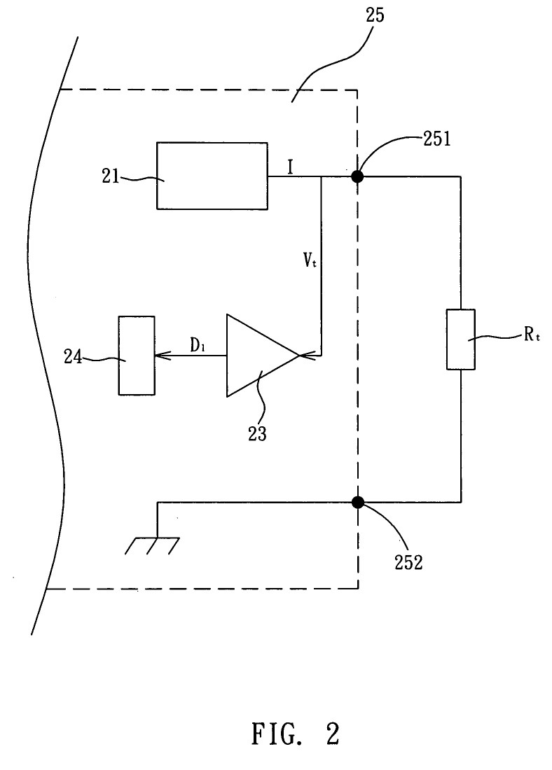

With reference to FIG. 2, a heat detector for a main board according to a preferred embodiment of the invention at least includes a current generation unit 21, a heat perception element Rₜ, an analog to digital converter (ADC) 23, and a control unit 24. In this embodiment, the current generation unit 21, the ADC 23, and the control unit 24 are integrated in a chip 25.

The current generation unit 21 is used to generate a current signal I. The heat perception element Rₜ electrically connects to the current generation unit 21 and generates an analog signal Vₜ according to the current signal I. Herein, the analog signal Vₜ is a voltage value. In this embodiment, the heat perception element Rₜ is a thermal resistor, which varies its resistance value with temperature.

The ADC 23 electrically connects to the current generation unit 21 and the heat perception element Rₜ. The ADC 23 is used to convert the analog signal Vₜ into at least one digital signal D₁, which may be 8-bit, 16-bit, or any other effective number of bits that a digital processor can process.

The control unit 24 electrically connects to the ADC 23, and converts the digital signal D₁ generated by the ADC 23 into temperature information, which is used for determining the required rotational speed of the fan.

Since the current generation unit 21, the ADC 23, and the control unit 24 are installed inside the chip 25, whereas the heat perception element Rₜ is installed outside the chip 25, the chip 25 has to provide a current generation pin 251 and a ground pin 252 respectively connected to the heat perception element Rₜ. The operation mechanism is that the current generation unit 21 generates a current signal I, which is transmitted via the current generation pin 251 to the heat perception element Rₜ, thereby generating an analog signal Vₜ according to the Ohm's law,
Vₜ=I×Rₜ

The ADC 23 converts the analog signal Vₜ into the digital signal D₁, which is then output to the control unit 24. The control unit 24 generates temperature information according to the digital signal D₁, and the required rotational speed of the fan is controlled by the temperature information. Moreover, the heat perception element Rₜ generates different resistances value according to different temperatures. Therefore, as the value of Rₜ varies, the analog signal received by the ADC 23 also changes. Different analog signals Vₜ are converted into different digital signals D₁, which are then converted into different temperature information. Therefore, different rotational speeds are used to cool the main board under different temperatures.

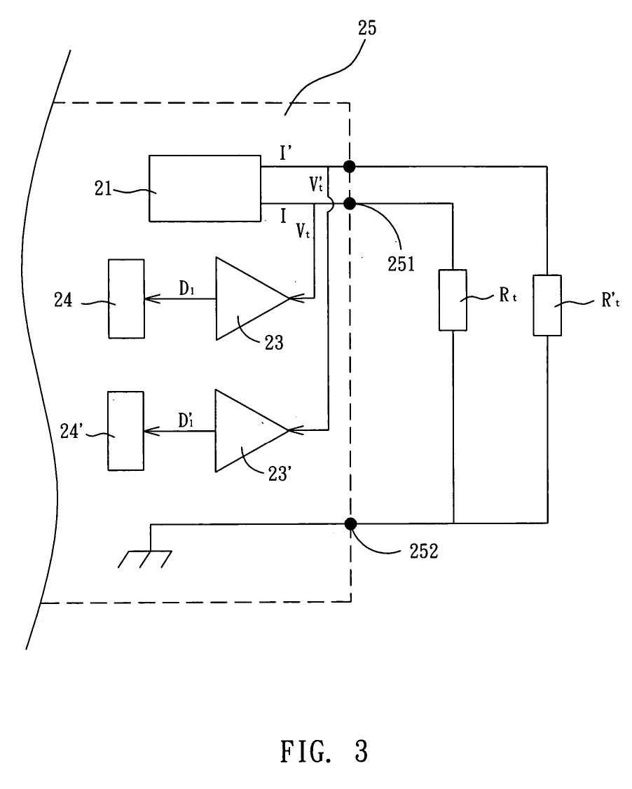

In summary, the conventional heat detector uses the reference voltage generator along with a resistor and a thermal resistor to produce a voltage on the thermal resistor by voltage division. However, the heat detector of the invention uses a current generation unit in place of the conventional reference voltage generator. Therefore, only one thermal resistor (Rₜ or R′ₜ) is needed for producing the analog signal (Vₜ or V′ₜ) required by the ADC (23 or 23′). As a result, the number of required pins on the chip can be reduced. Some components outside the chip are also unnecessary. In general, an ordinary main board requires more than one set of heat detector. The more heat detectors there are (as shown in FIG. 3), the invention can save more circuit layout space on the main board than the prior art.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A heat detector for a main board, comprising:
a current generation unit for generating a current signal;
a heat perception element electrically connected to the current generation unit and generating an analog signal according to the current signal; and
an analog to digital converter (ADC) electrically connected to the current generation unit and the heat perception element, and converting the analog signal into at least one digital signal.

2. The heat detector of claim 1, wherein the current generation unit and the ADC are integrated in a chip.

3. The heat detector of claim 1, further comprising:
a control unit electrically connecting to the ADC to convert the digital signal into temperature information.

4. The heat detector of claim 3, wherein the current generation unit, the ADC, and the control unit are integrated in a chip.

5. The heat detector of claim 1, wherein the heat perception element is a thermal resistor.

6. The heat detector of claim 1, wherein the analog signal is a voltage value.
